(19) United States
(12) Patent Application Publication
(10) Pub. No.: US 2024/0320024 A1
(43) Pub. Date: Sep. 26, 2024

(54) SYNCHRONIZING VIRTUAL INFRASTRUCTURE OBJECTS OF AUTONOMOUS CLUSTERS IN A VIRTUALIZED COMPUTING ENVIRONMENT

(71) Applicant: VMware, Inc., Palo Alto, CA (US)

(72) Inventors: Alkesh SHAH, Sunnyvale, CA (US); Brian Masao OKI, San Jose, CA (US); Leonid LIVSHIN, Malden, MA (US); Stanimir LUKANOV, Sofia (BG); Petko PADEVSKI, Troyan (BG); Dimo RAYCHEV, Varna (BG); Georgi Lyubomirov DIMITROV, Plovdiv (BG)

(21) Appl. No.: 18/189,131

(22) Filed: Mar. 23, 2023

(51) Int. Cl. G06F 9/455

(52) U.S. Cl. CPC G06F 9/45558; G06F 2009/45562; G06F 2009/4557

(57) ABSTRACT

An example method of synchronizing a first inventory of a cross-cluster control plane (xCCP) with a second inventory of a cluster control plane (CCP) includes: receiving, at a replication engine of the xCCP from the CCP, a notification of a CCP operation that modified an object in the second inventory; determining, by the replication engine, a first operation to modify the first inventory with the object; identifying, in a buffer of the replication engine, a second operation to modify the first inventory with a related object associated with the object, the related object included in an earlier CCP notification, received at the xCCP before the notification, but not used to modify the first inventory due to an unresolved dependency; and calling, by the replication engine in response to satisfaction of the unresolved dependency, a service of the xCCP to modify the first inventory by performing the first and second operations.

### BACKGROUND

A virtualization management server manages and controls a software-defined datacenter environment. That environment includes virtual infrastructure (VI) objects, such as host computers (“hosts”), virtual machines (VMs), datastores, clusters (sets of hosts), and the like. The virtualization management server executes on a virtualized host (e.g., in a VM) or non-virtualized host and maintains an inventory of the VI objects under management. The VI objects represent hierarchical structures with well-defined relationships.

To keep pace with changes in the SDDC, virtualization management servers are evolving to include a new type of cluster referred to as an “autonomous cluster.” An autonomous cluster includes a self-contained management plane referred to herein as a cluster control plane (CCP). The autonomous cluster can operate independently of the virtualization management server. Consequently, the virtualization management server's role changes with respect to autonomous clusters to become a cross-cluster control plane (xCCP) that coordinates operations that span clusters (both traditional and autonomous clusters).

A virtualization management server has the functionality to obtain VI object information from hypervisors executing in the hosts of a traditional cluster. However, in its role as an xCCP for an autonomous cluster, the server does not interact directly with hosts. Rather, the server interacts with the CCP of the autonomous cluster. A virtualization management server functioning as an xCCP requires new functionality to replicate hierarchical structures of VI objects from CCPs it manages across autonomous clusters. Such functionality allows a user a single “plane of glass” for cross-cluster control.

### SUMMARY

In an embodiment, a method of synchronizing a first inventory of a cross-cluster control plane (xCCP) with a second inventory of a cluster control plane (CCP) executing in and managing a virtualized host cluster is described. The method includes receiving, at a replication engine of the xCCP from the CCP, a notification of a CCP operation that modified an object in the second inventory. The object represents virtualized infrastructure (VI) in the virtualized host cluster. The method includes determining, by the replication engine, a first operation to modify the first inventory with the object. The method includes identifying, in a buffer of the replication engine, a second operation to modify the first inventory with a related object associated with the object, the related object included in an earlier CCP notification, received at the xCCP before the notification, but not used to modify the first inventory due to an unresolved dependency. The method includes calling, by the replication engine in response to satisfaction of the unresolved dependency, a service of the xCCP to modify the first inventory by performing the first and second operations.

Further embodiments include a non-transitory computer-readable storage medium comprising instructions that cause a computer system to carry/out the above method, as well as a computer system configured to carry out the above method.

### BRIEF DESCRIPTION OF THE DRAWINGS

FIG. 1 is a block diagram depicting a virtualized computing system according to embodiments.

FIG. 2 is a block diagram depicting a virtualized host cluster according to embodiments.

FIGS. 3A-3B are block diagrams depicting logical operation of a replication engine for performing cluster synchronization according to embodiments.

FIG. 4 illustrates an example CCP inventory and an example xCCP inventory.

FIG. 5 is a flow diagram depicting a method of synchronizing xCCP inventory and CCP inventory in a virtualized computing system.

FIG. 6A is a block diagram depicting an example autonomous cluster hierarchical structure modified by a CCP.

FIG. 6B is a flow diagram depicting a method of synchronizing the autonomous cluster hierarchical structure in FIG. 6A with xCCP inventory according to an embodiment.

FIG. 7A is a block diagram depicting an example autonomous cluster hierarchical structure modified by a CCP.

FIG. 7B is a flow diagram depicting a method of synchronizing the autonomous cluster hierarchical structure in FIG. 7A with xCCP inventory according to an embodiment.

FIG. 8 is a flow diagram depicting a method of proxying an operation at an xCCP that targets a replicated object corresponding to an object managed by an autonomous cluster according to embodiments.

### DETAILED DESCRIPTION

Synchronizing virtual infrastructure (VI) objects of autonomous clusters in a virtualized computing environment is described. An autonomous cluster comprises a virtualized host cluster having a self-contained management plane, referred to as a cluster control plane (CCP). The virtualized host cluster comprises hosts having hypervisors executing on hardware platforms thereof. The CCP is a self-contained management plane in that the CCP is capable of managing virtualized host cluster, including VI objects therein, independent from any other management plane (e.g., independent from a virtualization management server). VI objects (also referred to as “objects” or “managed objects”) comprise units of virtualized infrastructure. Example VI objects include datacenters, clusters, hosts, VMs, resource pools, datastores, folders (e.g., containers for VI objects), and the like. The virtualized computer environment can include one or more clusters, each of which can be a traditional cluster or autonomous cluster. A traditional cluster comprises a virtualized host cluster managed by an external management plane. In embodiments, an external management plane, referred to as a cross-cluster control plane (xCCP), manages the clusters in the virtualized computing environment. The xCCP manages a traditional cluster by communicating with host hypervisors. The xCCP manages an autonomous cluster by communicating with the CCP thereof.

Techniques are described herein for replicating hierarchical structures of VI objects from CCPs of autonomous clusters to an xCCP (“cluster synchronization”). During cluster synchronization, inventory modifications in the autonomous cluster are reflected in the inventory of the xCCP and vice versa. Cluster synchronization includes data consistency guarantees that are maintained for correctness of the system. In embodiments, the inventory of VI objects managed by the CCP in the autonomous cluster are represented in the inventory of the xCCP. The hierarchical structure of the CCP's inventory is preserved when replicated to the xCCP's inventory.

In this manner, a user can visualize and operate on constituent VI objects of autonomous clusters. Changes made by a CCP to its inventory are replicated to the inventory of the xCCP to maintain consistency. Such changes comprise adding VI objects, updating VI objects, or deleting VI objects. VI objects of an autonomous cluster represented in the xCCP's inventory mirror the corresponding VI objects in the CCP's inventory. Operations that target autonomous cluster VI objects in the xCCP's inventory are proxied to the CCP to be executed on the corresponding VI objects in the CCP's inventory. These and further aspects of the embodiments are described below with respect to the drawings.

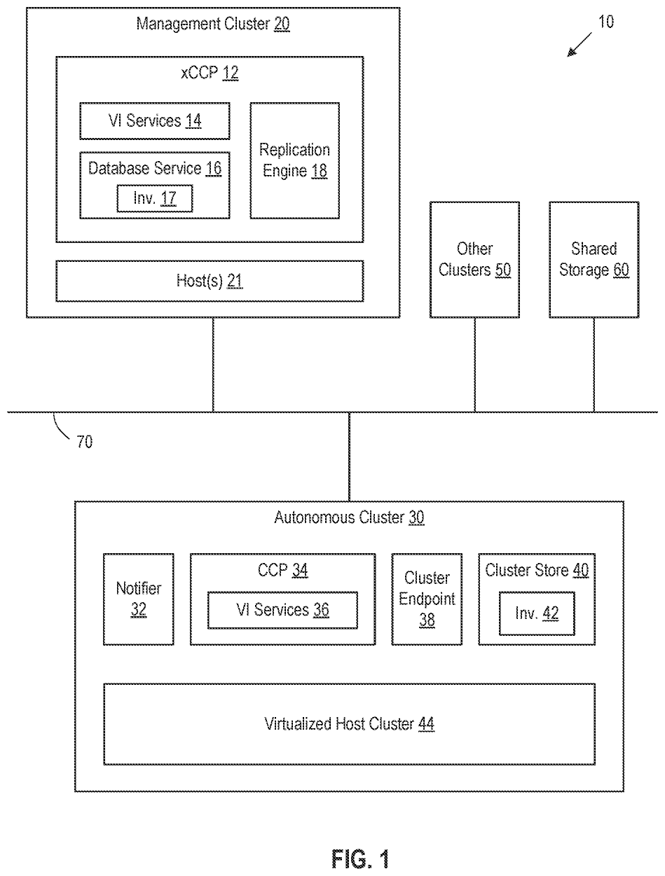

FIG. 1 is a block diagram depicting a virtualized computing system 10 according to embodiments. Virtualized computing system 10 includes an xCCP 12 and autonomous cluster 30 coupled to a physical network 70. xCCP 12 can execute in a management cluster 20, which can include one or more hosts 21. In an embodiment, xCCP 12 comprises functionality of a virtualization management server. Virtualized computing system 10 can include other clusters 50 (other autonomous clusters or traditional clusters) and shared storage 60. xCCP 12 provides a cross-cluster management plane for autonomous clusters, including autonomous cluster 30. xCCP 12 provides a management plane for any traditional clusters in other clusters 50.

Autonomous cluster 30 and other clusters 50 can access shared storage 60 over physical network 70. Shared storage 60 includes one or more storage arrays, such as a storage area network (SAN), network attached storage (NAS), or the like. Shared storage 60 may comprise magnetic disks, solid-state disks, flash memory, and the like as well as combinations thereof. In some embodiments, hosts in autonomous cluster 30 and/or other clusters 50 include local storage (e.g., hard disk drives, solid-state drives, etc.). The local storage in each host of cluster can be aggregated and provisioned as part of a virtual SAN, which is another form of shared storage 60.

xCCP 12 includes VI services 14, database service 16, and replication engine 18. xCCP 12 executes on a virtualized or non-virtualized host in management cluster 20. Management cluster 20 comprises one or more hosts. xCCP 12 communicates with hypervisors of hosts in traditional clusters and with CCP 34 in autonomous cluster 30 (and CCPs in any other autonomous clusters). For traditional clusters, xCCP 12 installs agents in hypervisors to add the hosts as managed objects. xCCP 12 logically groups hosts into traditional clusters and VI services 14 provide cluster-level functions to the hosts. A VI service 14 includes a software service that performs some SDDC function. For autonomous cluster 30, xCCP 12 can initially group hosts to form autonomous cluster 30 and provision software to autonomous cluster 30 that deploys CCP 34. Once formed, CCP 34 provides the management plane for autonomous cluster 30 and VI services 14 of xCCP 12 provide cross-cluster level functions among autonomous clusters. Database service 16 manages an inventory 17 of objects in virtualized computing system 10. Inventory 17 includes objects of traditional clusters, as well as objects of autonomous clusters Replication engine 18 functions to synchronize autonomous cluster inventories with xCCP 12.

Autonomous cluster 30 includes a notifier 32, CCP 34, a cluster endpoint 38, and a cluster store 40, which execute on a virtualized host cluster 44. CCP 34 includes VI services 36 that execute to provide a management plane for autonomous cluster. CCP 34 can execute on any host in virtualized host cluster 44 and can change hosts in the event of host failure, host maintenance, etc. Cluster endpoint 38 provides an interface for autonomous cluster 30 through which software can connect to CCP 34 Cluster store 40 comprises local storage on virtualized hosts cluster 44 (e.g., a virtual SAN) or shared storage 60 and is configured to store an inventory 42 of objects in autonomous cluster 30 managed by CCP 34. VI services 36 of CCP 34 make changes to inventory 42, which can include creating objects, updating objects, or deleting objects. Notifier 32 is configured to provide change notifications to replication engine 18 in xCCP 12 in response to changes to inventory 42 made by CCP 34. Notifier 32 can push change notifications to replication engine 18 or replication engine 18 can pull change notifications from notifier 32. Replication engine 18 processes change notifications to synchronize the object hierarchy in inventory 42 with the object hierarchy in inventory 17.

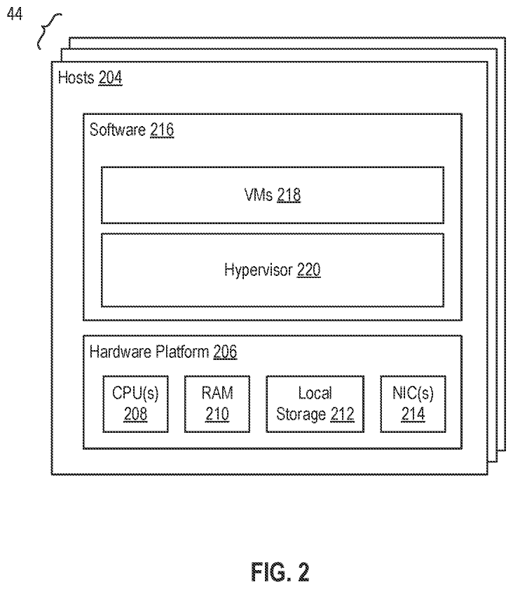

FIG. 2 is a block diagram depicting virtualized host cluster 44 according to embodiments. Virtualized host cluster 44 includes hosts 204 that may be constructed on hardware platforms such as an x86 or ARM architecture platforms. Note that host(s) 21 in management cluster 20 may be constructed the same or similar to hosts 204. As shown, a hardware platform 206 of each host 204 includes conventional components of a computing device, such as one or more central processing units (CPUs) 208, system memory (e.g., random access memory (RAM) 210), one or more network interface controllers (NICs) 214, and optionally local storage 212.

CPUs 208 are configured to execute instructions, for example, executable instructions that perform one or more operations described herein, which may be stored in RAM 210. The system memory is connected to a memory controller in CPU 208 or on hardware platform 206 and is typically volatile memory (e.g., RAM 210). Storage (e.g., local storage 212) is connected to a peripheral interface in CPU 208 or on hardware platform 206 (either directly or through another interface, such as NICs 214). Storage is persistent (nonvolatile). As used herein, the term memory (as in system memory) is distinct from the term storage (as in local storage or shared storage). NICs 214 enable host 204 to communicate with other devices through a physical network.

Software 216 of each host 204 provides a virtualization layer, referred to herein as a hypervisor 220, which directly executes on hardware platform 206. In an embodiment, there is no intervening software, such as a host operating system (OS), between hypervisor 220 and hardware platform 206. Thus, hypervisor 220 is a Type-1 hypervisor (also known as a “bare-metal” hypervisor) As a result, the virtualization layer in virtualized host cluster 44 (collectively hypervisors 220) is a bare-metal virtualization layer executing directly on host hardware platforms. Hypervisor 220 abstracts processor, memory, storage, and network resources of hardware platform 206 to provide a virtual machine execution space within which multiple virtual machines (VM) 218 may be concurrently instantiated and executed. Software executes in VMs 218, including components described in FIG. 1, such as xCCP 12, CCP 34, notifier 32, cluster endpoint 38, etc.

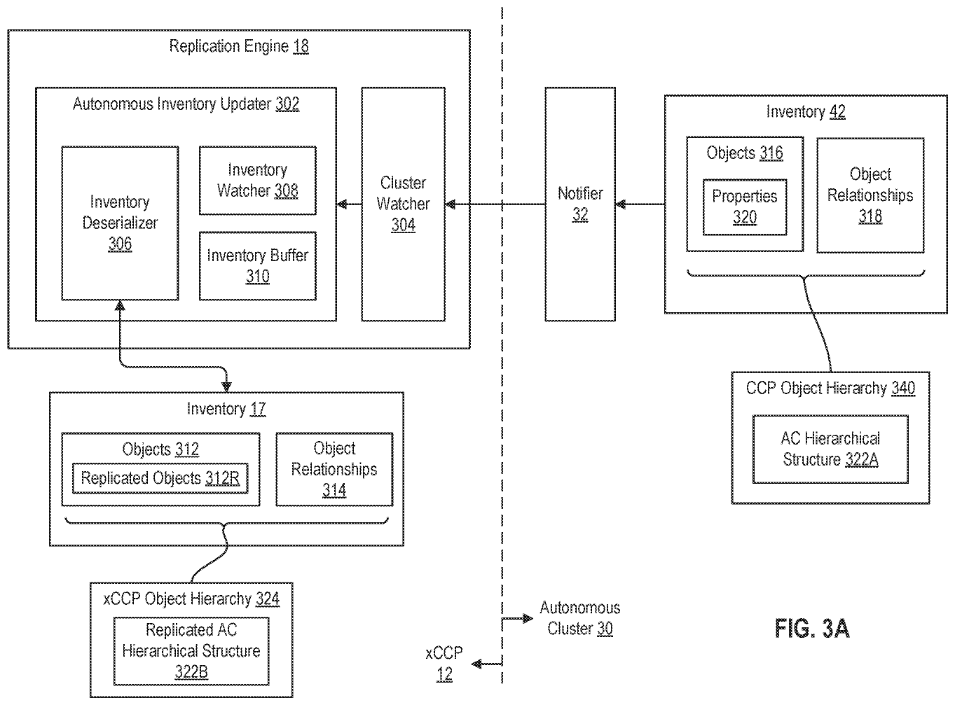

FIGS. 3A-B are block diagrams depicting logical operation of replication engine 18 for performing cluster synchronization according to embodiments. Replication engine 18 includes an autonomous inventory updater 302 and a cluster watcher 304. Cluster watcher 304 is configured to receive notifications 350 from notifier 32 (and any other notifier for any other autonomous cluster). Notifier 32 generates notifications 350 in response to modifications made to inventory 42 by CCP 34 (e.g., created objects, updated objects, deleted objects).

Inventory 42 includes objects 316 and object relationships 318. Each object 316 can include properties 320 and are VI objects that represent some VI in virtualized host cluster 44 (e.g., hosts, VMs, resource pools, datastores, etc.). Objects 316 include object relationships 318 forming a CCP object hierarchy 340. CCP 34 can add an object 316 to CCP object hierarchy 340 having a particular object relationship 318 (e.g., add a child object of a parent object). CCP 34 can update an object 316 by modifying a property 320 (e.g., update a parent object with an identifier of its child object). CCP 34 can delete an object 316 from CCP object hierarchy 340. Notifier 32 generates a notification 350 for each modification to CCP object hierarchy 340 in inventory 42.

Cluster watcher 304 receives notifications 350 from notifier 32. Cluster watcher 304 parses each notification 350 to learn a CCP operation 354 comprising an object 316 in inventory 42 modified by a CCP action 352 (e.g., create, update, or delete action). Cluster watcher 304 provides CCP operations 354 derived from notifications 350 to autonomous inventory updater 302. Autonomous inventory updater 302 is configured to update inventory 17 in response to CCP operations 354. Autonomous inventory updater 302 includes inventory watcher 308, inventory buffer 310, and inventory deserializer 306.

Inventory 17 includes objects 312 and object relationships 314. Each object 312 can include properties and are VI objects that represent some VI in virtualized computing system 10 (e.g., clusters, hosts, VMs, resource pools, datastores, etc.). Objects 312 include object relationships 314 forming an xCCP object hierarchy 324. Replication engine 18, based on notifications 350, replicates all or a portion of CCP object hierarchy 340 (AC hierarchical structure 322A) in xCCP object hierarchy 324 as replicated AC hierarchical structure 322B. Replication engine 18 maintains consistency between CCP object hierarchy 340 and xCCP object hierarchy 324.

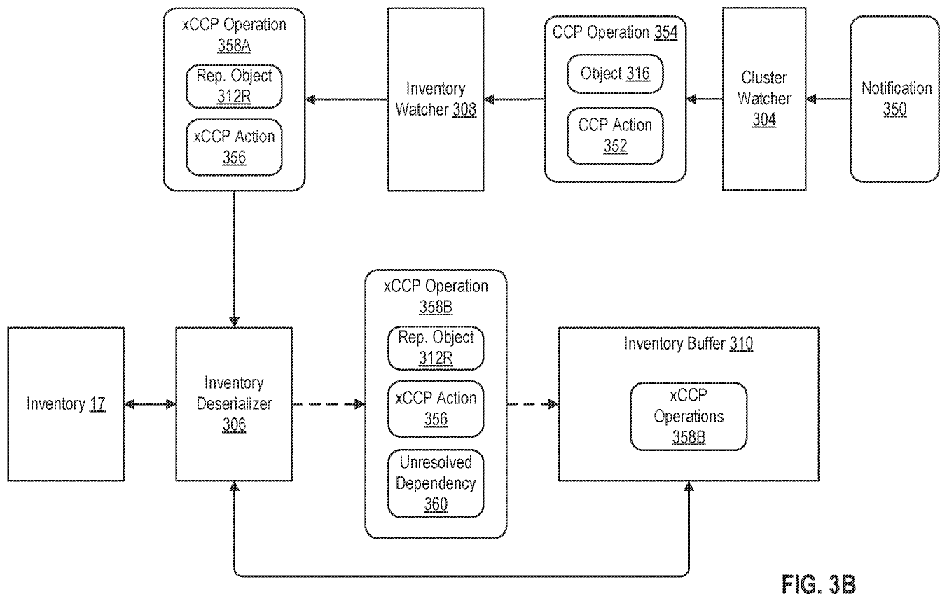

FIG. 4 illustrates an example CCP inventory 42 and an example xCCP inventory 17. CCP inventory 42 includes objects 316 for group-d1, datacenter, cluster-1, host-1, and vm-1. Group-d1 is a root object; datacenter is a child of group-d1; cluster-1 is a child of datacenter; host-1 is a child of cluster-1; and vm-1 is a child of host-1. xCCP inventory 17 include objects 312 for group-d1, datacenter, cluster-1, host-1, a8s-cluster, a8s-host, and a8s-vm. Group-d1 is a root object; datacenter is a child of group-d1; cluster-1 is a child of datacenter; and host-1 is a child of cluster-1. A8S-cluster is a child of datacenter; a8s-host is a child of a8s-cluster; and a8s-vm is a child of a8s-host. In the example, an AC hierarchical structure 322A comprises cluster-1, host-1, and vm-1. AC hierarchical structure 322A is replicated to inventory 17 as replicated AC hierarchical structure 322B. In embodiments, when replicating objects from inventory 42 to inventory 17, the nomenclature of the objects can be changed to avoid naming collisions in inventory 17. In the example, inventory 17 includes objects for cluster-1 and host-1 that for another cluster managed by xCCP and are children of object datacenter. Inventory 42 also includes objects cluster-1 and host-1 that are children of object datacenter but representing different objects in autonomous cluster 30. Objects cluster-1, host-1 and vm-1 in inventory 42 are replicated as objects a8s-cluster, a8s-host, and a8s-vm in inventory 17 using a nomenclature change to avoid naming collisions.

Returning to FIGS. 3A-B, inventory watcher 308 is configured to monitor inventory 17 for objects 312 that correspond to objects 316 in autonomous cluster 30 (“replicated objects 312R”). For an object 316 specified in CCP operation 354, inventory watcher 308 determines whether a corresponding replicated object 312R is present in inventory 17. If not, object 316 is a new object that needs to be created in inventory 17. Otherwise, object 316 is already replicated in inventory 17, but may require modification based on CCP action 352 (e.g., update or delete actions). Inventory watcher 308 generates an xCCP operation 358A having an xCCP action 356 targeting a replicated object 312R. xCCP action 356 can be a create action, an update action, or a delete action and depends on: 1) whether object 316 is already replicated in inventory 17 or is new; and 2) CCP action 352. xCCP action 356 may be the same as CCP action 352, or may be different depending on the state of replicated objects 312R in inventory 17. Replicated object 312R is a copy of object 316 in CCP operation 354. Replicated object 312R can be an object to be added to inventory 17 in case of a create action, an object to be removed from inventory 17 in case of a delete action, or an object to update an existing replicated object in inventory 17 in case of an update action. Inventory watcher 308 provides xCCP operations 358A to inventory deserializer 306. Note that object 316 in CCP operation 354 may include all its properties as maintained in inventory 42 or less than all its properties (e.g., only updated properties for update actions or ID properties for delete actions).

For an xCCP operation 358A, inventory deserializer 306 first checks with inventory 17 to determine if replicated object 312R has a dependency. If yes, inventory deserializer 306 checks with inventory buffer 310 to determine if replicated object 312R satisfies a dependency of a related object. If not, inventory deserializer 306 performs xCCP operation 358A by executing xCCP action 356 on inventory 17. If replicated object 312R does satisfy a related object's dependency, inventory deserializer 306 functions as described below.

Since object 316 is in AC hierarchical structure 322A, object 316 may depend on other objects. For example, a child object depends on its parent object, and in turn the parent object can depend on its child object (e.g., by including a reference to its children). AC hierarchical structure 322A can include other relationships between objects besides parent/child relationships that result in object dependencies (e.g., objects having references to each other). CCP 34 can modify one object, which in turn causes modification of related object(s) through object relationships 318. This CCP action results in multiple notifications 350, which cluster watcher 304 receives sequentially in some order. Thus, an xCCP operation 358A can specify a replicated object 3 12R that has related object(s) for which notifications have yet to be received by replication engine 18. Alternatively, an xCCP operation 358A can specify a replicated object 312R that resolves dependencies of related object(s) for which notifications have already been received.

Inventory buffer 310 functions as temporary storage for xCCP operations that are not yet applied to inventory 17 due to unresolved dependency (“xCCP operations 358B”). xCCP operation 358B includes an unresolved dependency 360 learned by inventory deserializer 306 that it cannot resolve (e.g., due to missing notification(s) for related object(s)). Inventory deserializer 306 adds xCCP operations 358B to inventory buffer 310. When inventory deserializer 306 learns of a dependency for replicated object 312R in xCCP operation 358A, inventory deserializer 306 checks inventory buffer 310 for any cached xCCP operation(s) targeting its related object(s). Even if there is no dependency for replicated object 312R, inventory deserializer 306 still checks inventory buffer 310 for any cached xCCP operation(s) for which replicated object 312R resolves dependency. If inventory buffer 310 has xCCP operation(s) 358B for all related object(s), inventory deserializer 306 removes such xCCP operation(s) from inventory buffer 310. Inventory deserializer 306 then performs xCCP operation 358A and xCCP operation(s) 358B in an ordered manner to modify inventory 17. Object changes cached in inventory buffer 310 are expected to be short-lived as notifications for related objects that resolve dependencies are expected to arrive within a narrow time window.

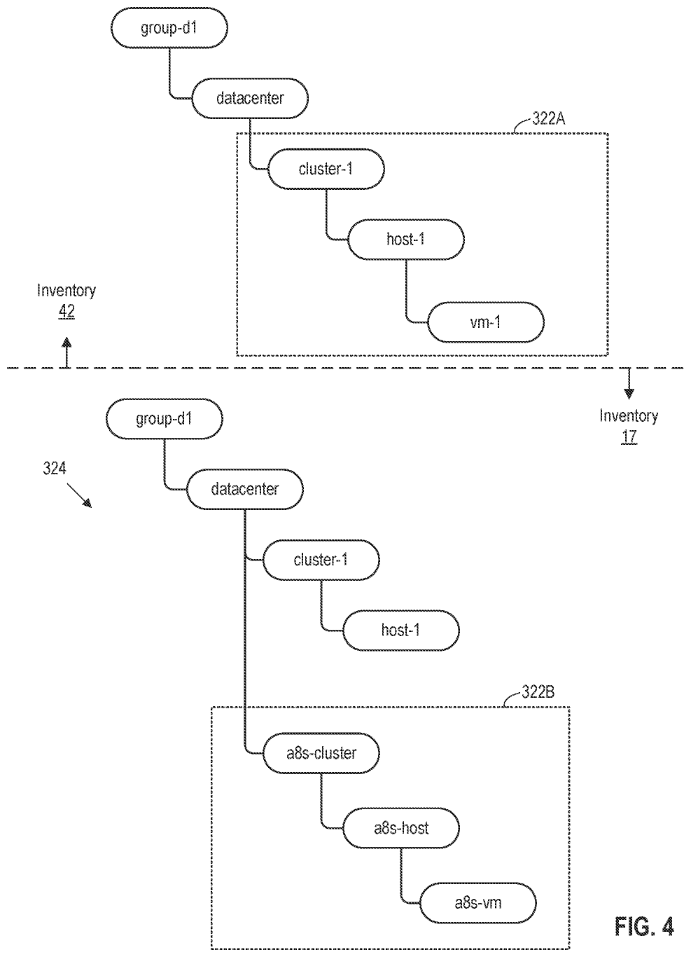

FIG. 5 is a flow diagram depicting a method 500 of synchronizing xCCP inventory and CCP inventory in a virtualized computing system. Method 500 begins at step 502, where cluster watcher 304 receives a notification 350 from autonomous cluster 30 (e.g., from notifier 32). Autonomous cluster 30 generates notification 350 in response to CCP 34 modifying inventory 42. At step 504, cluster watcher 304 parses notification 350 to learn a CCP operation 354 specifying a CCP action 352 and an object 316 targeted by CCP action 352.

At step 506, inventory watcher 308 determines an xCCP operation 358A specifying an xCCP action 356 and a replicated object 312R targeted by xCCP action 356. At step 508, inventory deserializer 306 checks inventory 17 and inventory buffer 310 to determine if replicated object 312R has dependency (e.g., replicated object is dependent on or has a relationship to a related object). At step 509, if replicated object 312R has dependency, method 600 proceeds to step 516. Otherwise, method 600 proceeds to step 510.

At step 510, inventory deserializer 306 determines if replicated object 312R satisfies any unresolved dependency of related object(s). If not, method 500 proceeds to step 514, where inventory deserializer 306 performs the xCCP operation to modify inventory 17 (e.g., perform xCCP action 356 with replicated object 312R). If at step 510 replicated object 312R does satisfy an unresolved dependency of a related object, method 500 proceeds to step 518.

As noted above, method 500 arrives at step 516 if replicated object 312R has dependency. At step 516, inventory deserializer 306 determines if that dependency is resolved (e.g., by xCCP operation(s) for related object(s) in inventory buffer 310). If not, method 500 proceeds to step 512, where inventory deserializer 306 caches an xCCP operation 358B in inventory buffer 310. If at step 516 the replicated object's dependency is resolved, method 500 proceeds to step 518.

At step 518, inventory deserializer 306 removes xCCP operation(s) 358B from inventory buffer 310 for related object(s). The related object(s) resolve dependency of replicated object 312R, replicated object 312R resolves dependency of the related object(s), or both. At step 520, inventory deserializer 306 performs an ordered sequence of xCCP operations 358A and 358B to modify inventory 17. This includes performing the corresponding xCCP actions on replicated object 312R and the related object(s). At optional step 522, inventory deserializer 306 changes the nomenclature of replicated object(s) 312 in inventory 17 if necessary.

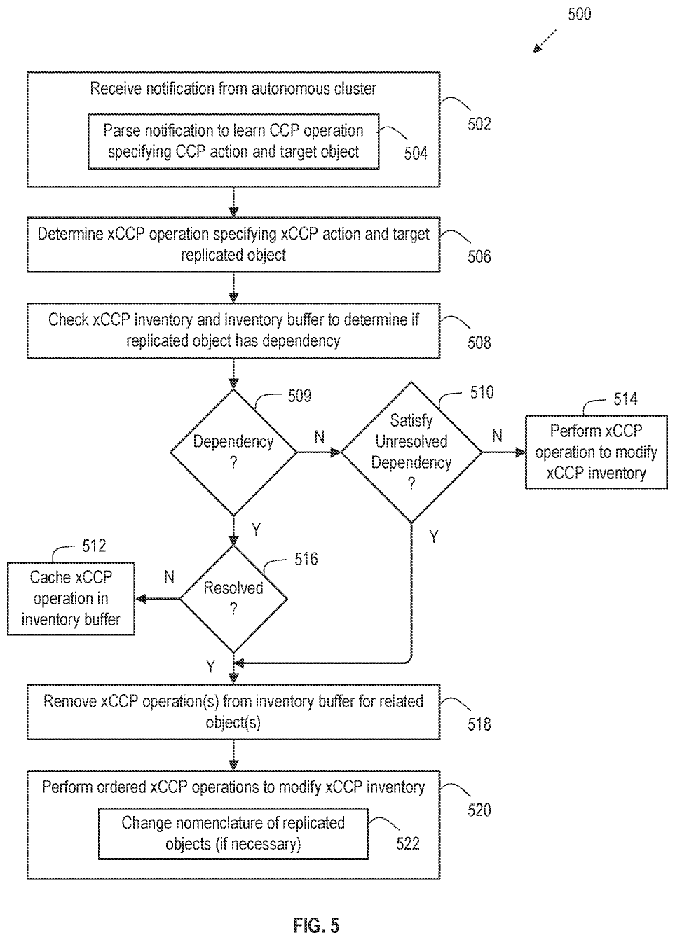

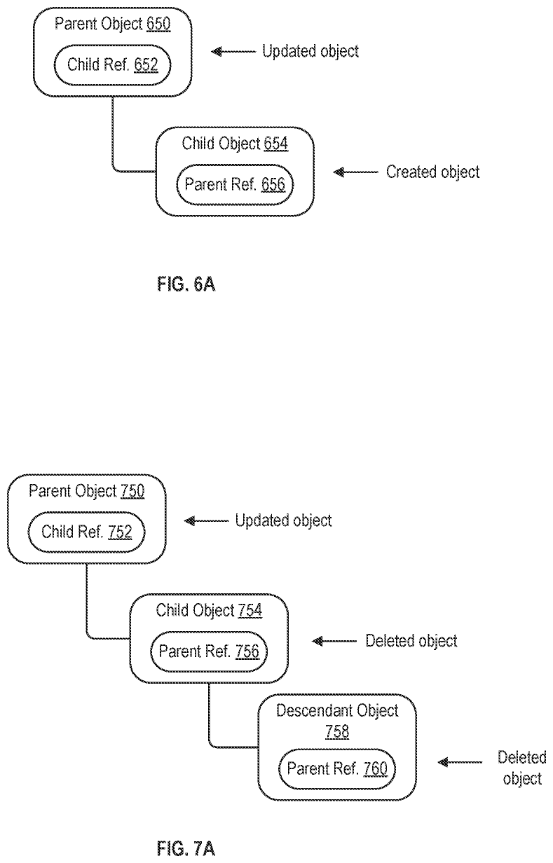

FIG. 6A is a block diagram depicting an example autonomous cluster hierarchical structure modified by a CCP. In the example, the hierarchical structure includes a parent object 650 and a child object 654 of parent object 650. Parent object 650 includes a reference to its child object 654 (“child reference 652”). Child object 654 includes a reference to its parent object (“parent reference 656”). CCP 34 modified inventory 42 to add child object 654 and update parent object 650 (e.g., update child reference 652). For example, parent object 650 can be a host and child object can be a VM created on the host.

FIG. 6B is a flow diagram depicting a method 600 of synchronizing the autonomous cluster hierarchical structure in FIG. 6A with xCCP inventory according to an embodiment. Replication engine 18 and its components are described above. For purposes of clarity by explanation, method 600 is described with respect to replication engine 18 in general as opposed to its specific components, the operation of which is described above.

Method 600 begins at step 602, where replication engine 18 learns a first CCP operation specifying creation of child object 654 from a first notification from the autonomous cluster. At step 604, replication engine 18 generates a first xCCP operation to create the child object in inventory 17. At step 606, replication engine 18 determines that child object 654 has an unresolved dependency on parent object 650. At step 608, replication engine 18 buffers the first xCCP operation due to the unresolved dependency.

At step 610, replication engine 18 learns of a second CCP operation specifying an update to parent object 650 in a second notification. At step 612, replication engine 18 generates a second xCCP operation to update parent object 650. At step 614, replication engine 18 determines that parent object 650 has a dependency on child object 654. At step 616, replication engine 18 determines that parent object 650 and child object 654 satisfy all dependencies. At step 618, replication engine 18 performs the first and second xCCP operations to create the child object and update the parent object.

In method 600, a notification for creation of the child object is received before a notification for update of the parent object. Those skilled in the art will appreciate that the notifications can be in reverse order and method 600 would proceed similarly by first processing the xCCP operation for the parent object and then processing the xCCP operation for the child object.

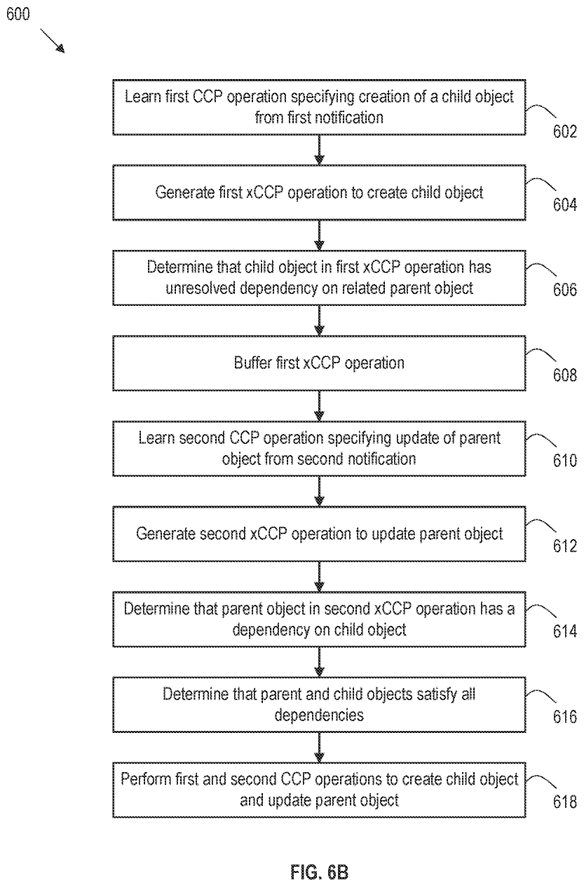

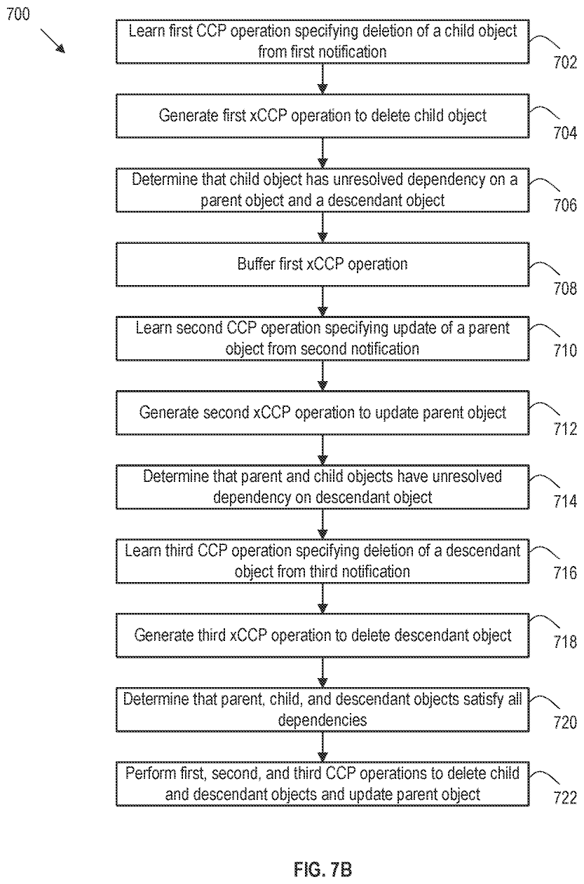

FIG. 7A is a block diagram depicting an example autonomous cluster hierarchical structure modified by a CCP. In the example, the hierarchical structure includes a parent object 750, a child object 754 of parent object 750, and a descendant object 758 of child object 754 (e.g., a child of the child object in the example). Parent object 750 includes a reference to its child object 754 (“child reference 752”). Child object 754 includes a reference to its parent object (“parent reference 756”). Descendant object 758 includes a reference it its parent (“parent reference 760”), which is child object 754 in the example. CCP 34 modified inventory 42 to delete child object 754. As a result, all descendants of child object 754 are deleted (e.g., descendant object 758) and parent object 750 is updated (e.g., removing reference to child object 754).

FIG. 7B is a flow diagram depicting a method 700 of synchronizing the autonomous cluster hierarchical structure in FIG. 7A with xCCP inventory according to an embodiment. Replication engine 18 and its components are described above. For purposes of clarity by explanation, method 700 is described with respect to replication engine 18 in general as opposed to its specific components, the operation of which is described above.

Method 700 begins at step 702, where replication engine 18 learns a first CCP operation specifying deletion of child object 754 from a first notification from the autonomous cluster. At step 704, replication engine 18 generates a first xCCP operation to delete the child object in inventory 17. At step 706, replication engine 18 determines that child object 754 has an unresolved dependency on parent object 750 and descendent object 758. At step 708, replication engine 18 buffers the first xCCP operation due to the unresolved dependency.

At step 710, replication engine 18 learns of a second CCP operation specifying an update to parent object 750 in a second notification. At step 712, replication engine 18 generates a second xCCP operation to update parent object 750. At step 714, replication engine 18 determines that parent object 750 and child object 754 have unresolved dependency on descendent object 758.

At step 716, replication engine 18 learns of a third CCP operation specifying a deletion of descendant object 758 in a third notification. At step 718, replication engine 18 generates a third xCCP operation to delete descendant object 758. At step 720, replication engine 18 determines that parent object 750, child object 754, and descendant object 758 satisfy all dependencies. At step 722, replication engine 18 performs the first, second, and third xCCP operations to delete child and descendant objects 754 and 758 and update parent object 750.

In method 700, a notifications are received in a certain order of deletion of child, update of parent, and deletion of descendant. Those skilled in the art will appreciate that the notifications may come in any order and method 700 would proceed similarly and achieve the same result.

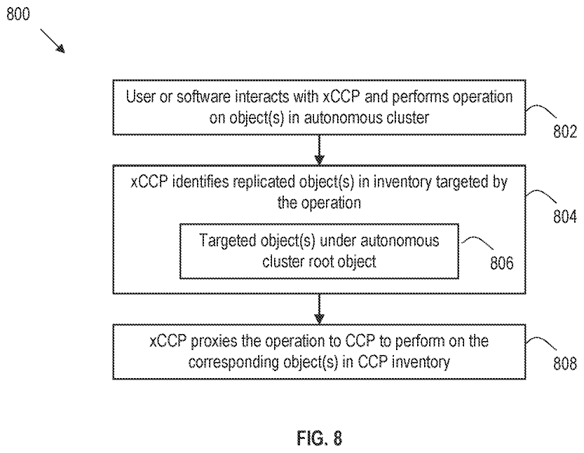

FIG. 8 is a flow diagram depicting a method 800 of proxying an operation at an xCCP that targets a replicated object corresponding to an object managed by an autonomous cluster according to embodiments. Method 800 begins at step 802, where a user or software interacts with xCCP 12 and performs an operation on object(s) in autonomous cluster 30 as such objects are presented in inventory 17. At step 804, xCCP 12 identifies replicated object(s) in inventory 17 targeted by the operation. The targeted replicated object(s) are under an autonomous cluster root object (806). At step 808, xCCP 12 proxies the operation to CCP 34 to perform on the corresponding object(s) in inventory 42.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of synchronizing a first inventory of a cross-cluster control plane (xCCP), with a second inventory of a cluster control plane (CCP) executing in and managing a virtualized host cluster, the method comprising:
receiving, at a replication engine of the xCCP from the CCP, a notification of a CCP operation that modified an object in the second inventory, the object representing virtualized infrastructure (VI) in the virtualized host cluster;
determining, by the replication engine, a first operation to modify the first inventory with the object;
identifying, in a buffer of the replication engine, a second operation to modify the first inventory with a related object associated with the object, the related object included in an earlier CCP notification, received at the xCCP before the notification, but not used to modify the first inventory due to an unresolved dependency; and
calling, by the replication engine in response to satisfaction of the unresolved dependency, a service of the xCCP to modify the first inventory by performing the first and second operations.

2. The method of claim 1, wherein the object is a parent object, wherein the related object is a child object of the parent object, wherein the unresolved dependency comprises a relationship between the parent object and the child object, and wherein the method comprises:
determining, by the replication engine, that receipt of the CCP operation on the parent object satisfies the unresolved dependency.

3. The method of claim 1, wherein the object is a child object, wherein the related object is a parent object of the child object, wherein the unresolved dependency comprises a relationship between the parent object and the child object, and wherein the method comprises:
determining, by the replication engine, that receipt of the CCP operation on the child object satisfies the unresolved dependency.

4. The method of claim 1, further comprising:
receiving, at the replication engine, the earlier notification of another CCP operation that modified the related object in the second inventory;
determining by the replication engine, the second operation to modify the first inventory with the related object;
determining, by the replication engine, that the related object has the unresolved dependency; and
adding, by the replication engine, the second operation to the buffer.

5. The method of claim 1, wherein the first operation comprises a first action to be performed in the first inventory with respect to the object, wherein the second operation comprises a second action to be performed in the first inventory with respect to the related object, and wherein each of the first action and the second action comprise one of a create action, an update action, or a delete action.

6. The method of claim 1, wherein the CCP operation comprises an action performed in the second inventory with respect to the object, the action being one of a create action, an update action, or a delete action.

7. The method of claim 1, wherein the first and second operations modify the first inventory with the object and the related object using a different nomenclature from that used by the object and the related object in the first inventory of the CCP.

8. The method of claim 1, wherein the replication engine modifies the first inventory with the object and the related object under a root object that refers to the virtualized host cluster, and wherein the method comprises:
executing, at a VI service of the xCCP, an operation on a target object under the root object; and
proxying, by the xCCP, the operation to the CCP to operate on an object in the second inventory replicated by the target object.

9. The method of claim 1, wherein the related object is a child object, wherein the object is a parent object of the child object, wherein the earlier notification specified another CCP operation that deleted the child object in the second inventory, wherein the CCP operation is an update to the parent object in the second inventory, wherein the parent object satisfies the unresolved dependency, wherein the first operation comprises updating the parent object, and wherein the second operation comprises deleting the child object.

10. The method of claim 9, wherein the related object is a child object, wherein the object is a parent object of the child object, wherein the earlier notification specified another CCP operation that deleted the child object in the second inventory, wherein the CCP operation is an update to the parent object in the second inventory, wherein the first operation comprises updating the parent object, and wherein the second operation comprises deleting the child object, wherein the replication engine adds the first operation to the buffer in response to the parent object failing to satisfy the unresolved dependency, and wherein the method comprises:
receiving, at the replication engine, another notification of an additional CCP operation that deleted a descendant object of the child object from the second inventory;
determining, by the replication engine, a third operation to delete the descendant object from the first inventory; and
determining, by the replication engine, that the descendant object together with the parent object and the child object satisfy the unresolved dependency;
wherein the step of calling comprises performing the first, the second, and the third operations.

11. A non-transitory computer readable medium comprising instructions to be executed in a computing device to cause the computing device to carry out a method of synchronizing a first inventory of a cross-cluster control plane (xCCP), with a second inventory of a cluster control plane (CCP) executing in and managing a virtualized host cluster, the method comprising:
receiving, from the CCP, a notification of a CCP operation that modified an object in the second inventory, the object representing virtualized infrastructure (VI) in the virtualized host cluster;
determining a first operation to modify the first inventory with the object;
identifying, in a buffer, a second operation to modify the first inventory with a related object associated with the object, the related object included in an earlier CCP notification, received at the xCCP before the notification, but not used to modify the first inventory due to an unresolved dependency; and
calling, in response to satisfaction of the unresolved dependency, a service of the xCCP to modify the first inventory by performing the first and second operations.

12. The non-transitory computer readable medium of claim 11, wherein the object is a parent object, wherein the related object is a child object of the parent object, wherein the unresolved dependency comprises a relationship between the parent object and the child object, and wherein the method comprises:
determining that receipt of the CCP operation on the parent object satisfies the unresolved dependency.

13. The non-transitory computer readable medium of claim 11, wherein the object is a child object, wherein the related object is a parent object of the child object, wherein the unresolved dependency comprises a relationship between the parent object and the child object, and wherein the method comprises:
determining that receipt of the CCP operation on the child object satisfies the unresolved dependency.

14. The non-transitory computer readable medium of claim 11, wherein the first operation comprises a first action to be performed in the first inventory with respect to the object, wherein the second operation comprises a second action to be performed in the first inventory with respect to the related object, and wherein each of the first action and the second action comprise one of a create action, an update action, or a delete action.

15. The non-transitory computer readable medium of claim 11, wherein the first inventory is modified with respect to the object and the related object under a root object that refers to the virtualized host cluster, and wherein the method comprises:
executing an operation on a target object under the root object; and
proxying the operation to the CCP to operate on an object in the second inventory replicated by the target object.

16. A computer system, comprising:
a cross-cluster control plane (xCCP) executing on a management cluster and having a first inventory; and
a virtualized host cluster configured to execute a cluster control plane (CCP) that managed the virtualized host cluster, the CCP having a second inventory;
wherein the xCCP is configured to:
receive, from the CCP, a notification of a CCP operation that modified an object in the second inventory, the object representing virtualized infrastructure (VI) in the virtualized host cluster;
determine a first operation to modify the first inventory with the object;
identify, in a buffer, a second operation to modify the first inventory with a related object associated with the object, the related object included in an earlier CCP notification, received at the xCCP before the notification, but not used to modify the first inventory due to an unresolved dependency; and
call, in response to satisfaction of the unresolved dependency, a service of the xCCP to modify the first inventory by performing the first and second operations.

17. The computer system of claim 16, wherein the object is a parent object, wherein the related object is a child object of the parent object, wherein the unresolved dependency comprises a relationship between the parent object and the child object, and wherein the xCCP is configured to:
determine that receipt of the CCP operation on the parent object satisfies the unresolved dependency.

18. The computer system of claim 16, wherein the object is a child object, wherein the related object is a parent object of the child object, wherein the unresolved dependency comprises a relationship between the parent object and the child object, and wherein the xCCP is configured to:
determining that receipt of the CCP operation on the child object satisfies the unresolved dependency.

19. The computer system of claim 18, wherein the first operation comprises a first action to be performed in the first inventory with respect to the object, wherein the second operation comprises a second action to be performed in the first inventory with respect to the related object, and wherein each of the first action and the second action comprise one of a create action, an update action, or a delete action.

20. The computer system of claim 16, wherein the first inventory is modified with respect to the object and the related object under a root object that refers to the virtualized host cluster, and wherein the xCCP is configured to:
execute, at a VI service, an operation on a target object under the root object; and
proxy the operation to the CCP to operate on an object in the second inventory replicated by the target object.
